(19) United States
(12) Patent Application Publication
(10) Pub. No.: US 2009/0210567 A1
(43) Pub. Date: Aug. 20, 2009

(54) HOST APPARATUS AND METHOD FOR CONTROLLING THE SAME

(75) Inventors: Tadashi Shinohara, Tarumizu-shi (JP); Hiroyuki Hashimoto, Suwa-gun (JP); Tsukasa Kubota, Aira-gun (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/389,733

(22) Filed: Feb. 20, 2009

(30) Foreign Application Priority Data
Feb. 20, 2008 (JP) 2008-038654

(51) Int. Cl. G06F 12/02; G06F 3/00

(52) U.S. Cl. 710/13; 710/8; 710/16

(57) ABSTRACT

A host apparatus communicates with a server that stores binary data containing a host apparatus supporting program that is necessary when the host apparatus is used with a predetermined one of a plurality of devices and a download program that downloads the host apparatus supporting program to the predetermined device, recognizes the predetermined device when the predetermined device is connected to the host apparatus, outputs a request to acquire the binary data to the server, stores the binary data in a storage unit of the host apparatus when the server inputs the binary data, executes the download program contained in the binary data stored in the storage unit to download the host apparatus supporting program to the predetermined device, and deletes the binary data from the storage unit after the download program is executed or when the use of the predetermined device is completed.

### CROSS REFERENCE TO RELATED APPLICATIONS

The present application claims priority from Japanese Patent Application No. 2008-038654 filed on Feb. 20, 2008, which is hereby incorporated by reference in its entirety.

### BACKGROUND

In an existing printer and other devices, when a memory card that stores firmware is loaded, the firmware is read from the memory card and allocated in a memory (see Japanese Patent Publication No. JP-A-2005-94301, for example).

A device of this type is a low-end model having a small amount of memory capacity in many cases, and needs to contain a download program that reads firmware from the memory card and allocates it in a memory. The memory capacity cannot therefore be sufficiently reduced. On the other hand, it is conceivable to save firmware programs that correspond to a large number of models in a memory in a personal computer having a sufficient amount of memory capacity, connect a device to the personal computer, instruct the personal computer to search the firmware program that corresponds to the device, and instruct the personal computer to download the firmware to the device. In this case, the device needs to contain no download program. It is also conceivable to connect a device to a host apparatus instead of a personal computer and similarly instruct the host apparatus to download a firmware program to the device.

However, the memory capacity of a host apparatus is smaller than that of a personal computer, and is not large enough to save firmware programs that correspond to a very large number of models. The number of models to be supported is therefore disadvantageously limited. Further, when the devices that require the firmware programs will not be connected, the memory has unnecessary data as a result, and the memory is not used efficiently.

### SUMMARY

An embodiment of the disclosure is to provide a host apparatus and a method for controlling the same that allow any of various types of devices connected to the host apparatus to be used even when the host apparatus does not have a sufficient amount of storage capacity.

A host apparatus according to at least one embodiment of the disclosure sends and receives data to and from any of a plurality of devices and includes

a storage unit that temporarily stores the data,

a device connection unit that may be connected to any of the plurality of devices,

a communication unit that may communicate with a server that stores binary data containing a host apparatus supporting program that is necessary when the host apparatus is used with a predetermined one of the plurality of devices and a download program that downloads the host apparatus supporting program to the predetermined device, and

a control unit that recognizes the predetermined device when the predetermined device is connected to the device connection unit, outputs a request to acquire the binary data to the server via the communication unit, stores the binary data in the storage unit when the server inputs the binary data, executes the download program contained in the binary data stored in the storage unit to download the host apparatus supporting program to the predetermined device, and deletes the binary data from the storage unit after the download program is executed or when the use of the predetermined device is completed.

In the host apparatus, when a predetermined device is connected to the device connection unit, the predetermined device is recognized, and a request to acquire the binary data that corresponds to the device (binary data containing a host apparatus supporting program that is necessary when the host apparatus is used with the predetermined device and a download program that downloads the host apparatus supporting program to the predetermined device) is outputted to the server via the communication unit. When the server inputs the binary data, the binary data is stored in the storage unit, and the download program contained in the binary data stored in the storage unit is executed to download the host apparatus supporting program to the predetermined device. The binary data is deleted from the storage unit after the download program is executed or when the use of the predetermined device is completed. Therefore, in the host apparatus, the storage unit does not need to store all host apparatus supporting programs that are necessary for various types of devices, but the storage unit only needs to store binary data containing a host apparatus supporting program necessary for a device to be used. The storage capacity of the storage unit may therefore be advantageously small. Further, the host apparatus may be used with any of the plurality of devices, in particular, a device that does not permanently hold a host apparatus supporting program or cannot download such a program by itself.

In the host apparatus according to at least one embodiment of the disclosure, the control unit may delete the binary data from the storage unit when the control unit detects the turning off of a power supply switch to be the completion of the use of the predetermined device. No unnecessary binary data is thus left in the storage unit when the power supply switch is turned on next time.

In the host apparatus according to at least one embodiment of the disclosure, the control unit may delete the binary data from the storage unit when the control unit detects the disconnection of the predetermined device from the device connection unit to be the completion of the use of the predetermined device. The corresponding capacity of the storage unit may thus be freed.

In the host apparatus according to at least one embodiment of the disclosure, the predetermined device may be any of a scanner, a tablet, and a digital camera, and the host apparatus may be a projector. In this configuration, the projector may project a document or a photograph read with the scanner, an illustration or a picture created on the tablet, or an image captured with the digital camera on a screen.

In the host apparatus according to at least one embodiment of the disclosure, the host apparatus supporting program may be firmware or a driver.

A method for controlling a host apparatus including a storage unit that temporarily stores data according to other embodiments of the disclosure, a device connection unit that may be connected to any of a plurality of devices, and a communication unit that may communicate with a server that stores binary data containing a host apparatus supporting program that is necessary when the host apparatus is used with a predetermined one of the plurality of devices and a download program that downloads the host apparatus supporting program to the predetermined device. The method includes

recognizing the predetermined device when the predetermined device is connected to the device connection unit, and outputting a request to acquire the binary data to the server via the communication unit, and

after the recognition of the device and the output of the request, storing the binary data in the storage unit when the server inputs the binary data, executing the download program contained in the binary data stored in the storage unit, and deleting the binary data from the storage unit after the download program is executed or when the use of the predetermined device is completed.

According to the method for controlling a host apparatus, when a predetermined device is connected to the device connection unit, the predetermined device is recognized, and a request to acquire the binary data that corresponds to the device (binary data containing a host apparatus supporting program that is necessary when the host apparatus is used with the predetermined device and a download program that downloads the host apparatus supporting program to the predetermined device) is outputted to the server via the communication unit. When the server inputs the binary data, the binary data is stored in the storage unit, and the download program contained in the binary data stored in the storage unit is executed to download the host apparatus supporting program to the predetermined device. The binary data is deleted from the storage unit after the download program is executed or when the use of the predetermined device is completed. Therefore, in the host apparatus, the storage unit does not need to store all host apparatus supporting programs that are necessary for various types of devices, but the storage unit only needs to store binary data containing a host apparatus supporting program necessary for a device to be used. The storage capacity of the storage unit may therefore be advantageously small. Further, the host apparatus may be used with any of the plurality of devices, in particular, a device that does not permanently hold a host apparatus supporting program or cannot download such a program by itself. It is noted that the control method described above may further includes a step for achieving effects and functions provided by the components in the host apparatus of the above aspect of the disclosure.

### BRIEF DESCRIPTION OF THE DRAWINGS

Embodiments of the disclosure are described with reference to the accompanying drawings, wherein like reference numbers reference like elements.

FIG. 1 is a block diagram showing a schematic configuration of a projector 10.

FIG. 2 is a descriptive diagram showing a procedure to perform a scan-to-projection process.

FIG. 3 is a descriptive diagram showing an example of binary data allocated in a RAM 36.

### DESCRIPTION OF EMBODIMENTS

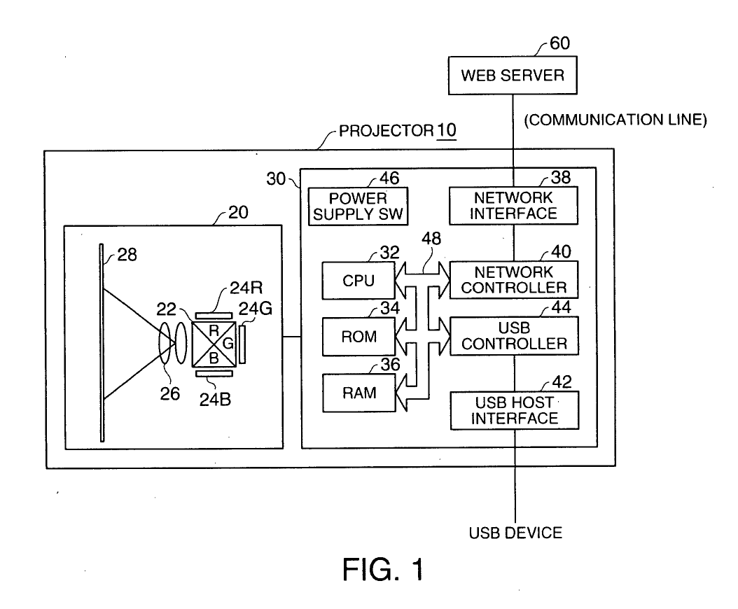

An embodiment of the disclosure will be described below. FIG. 1 is a block diagram showing a schematic configuration of a projector 10, which is an example of a host apparatus.

The projector 10 includes an image projection unit 20 that projects an image on a screen 28 and a main controller 30 that controls each portion of the image projection unit 20. The projector 10 is called a model A in the present embodiment.

The image projection unit 20 has what is called a three-LCD structure in which light emitted from a lamp (not shown) is separated into three, red (R), green (G), and blue (B), color light beams, which pass through transmissive liquid crystal panels 24R, 24G, and 24B that face three surfaces of a prism 22 and enter the prism 22, and an image obtained by combining the color light beams in the prism 22 is displayed on the screen 28 through a projection lens 26. The prism 22 is formed by bonding four rectangular prisms, and dielectric multilayer films are formed on the X-shaped interfaces between these bonded rectangular prisms. One of the dielectric multilayer films reflects the red light, whereas the other dielectric multilayer film reflects the blue light.

The main controller 30 includes a CPU 32 that performs various types of control and calculates and processes data, a ROM 34 that stores various types of processing programs, a RAM 36 that temporarily stores and saves data, a network controller 40 that sends and receives data to and from a web server 60 connected to a network interface 38 via a communication line, a USB controller 44 that sends and receives data to and from a USB device (a USB memory, scanner, and tablet, for example) connected to a USB host interface 42, and a power supply switch 46 that switches a power supply between ON and OFF. The CPU 32, the ROM 34, the RAM 36, the network controller 40, and the USB controller 44 are connected to one another via a bus 48. The main controller 30 drives the portions in the image projection unit 20 based on an image signal inputted from the USB device connected to the USB host interface 42 so as to project an image on the screen 28. The main controller 30 downloads binary data from the web server 60 connected to the network interface 38 via the communication line and allocates the data in the RAM 36, and downloads firmware, drivers, and other data contained in the allocated binary data to the USB device connected to the USB host interface 42.

Various types of firmware programs are saved in a built-in HDD (not shown) in the web server 60. The various types of firmware programs include a firmware program that is necessary when a certain model of projector is used with a certain model of scanner, and a firmware program that is necessary when a certain model of projector is used with a certain model of tablet. Each of the firmware programs is provided in the form of binary data.

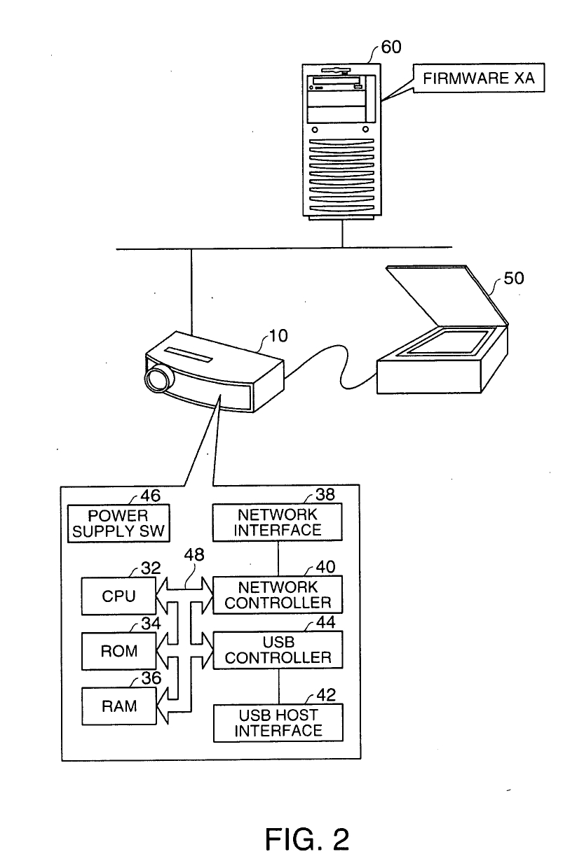

A specific example of how to use the projector 10 will be described with reference to FIG. 2. The description will be made with reference to a case where a model-X scanner 50 and a model-Y scanner 52, which are USB devices, are used. In this example, the scanner 50 is connected to the USB host interface 42 of the projector 10, and the projector 10 projects a document or a photograph read with the scanner 50 on the screen 28 (scan-to-projection). FIG. 2 is a descriptive diagram showing a procedure to perform the scan-to-projection process. Since the model-X scanner 50 is a low-end model that does not permanently hold firmware in the main body or cannot download firmware by itself, a host apparatus (the projector 10, for example), when connected to the scanner 50, needs to download the firmware to the scanner 50.

First, a user connects the scanner 50 to the USB host interface 42 of the projector 10. The USB controller 44 of the projector 10 automatically recognizes the connected USB device. In this description, the USB controller 44 automatically recognizes that the USB device is the model-X scanner 50. The USB controller 44 then outputs a request to the web server 60 via the network controller 40, the request asking to acquire firmware XA that is necessary when the model-A projector 10 is used with the model-X scanner 50. The web server 60 to which the acquisition request is inputted searches the firmware XA among a large number of firmware programs saved in the built-in HDD, and outputs binary data containing the firmware XA to the projector 10. The binary data in a compressed form is outputted to the projector 10.

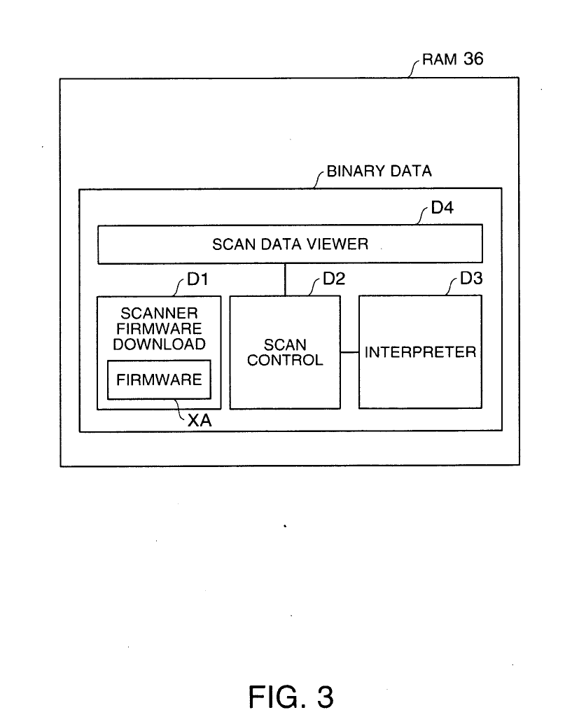

The network controller 40 receives the binary data from the web server 60, decompresses the compressed binary data, and allocates the binary data in a predetermined area in the RAM 36. FIG. 3 shows an example of the binary data allocated in the RAM 36. In the present embodiment, the allocated binary data includes a scanner firmware download program D1 that downloads the firmware XA to the scanner 50, a scan control program D2 that issues a command to the model-X scanner 50, an interpreter D3, which is software that converts the scan control program D2 into object codes and executes them at the same time, and a scan data viewer program D4 that attaches scanned data obtained from the model-X scanner 50 onto a predetermined mount area to produce image data. The firmware XA is stored in the RAM 36 as part of the scanner firmware download program D1.

The USB controller 44 then reads and executes the scanner firmware download program D1 allocated in the RAM 36, and downloads the firmware XA, which has been downloaded from the web server 60, to the scanner 50 (step S6). As a result, the scanner 50 holds the firmware XA in an internal memory, whereby the scanner 50 can send and receive data to and from the projector 10. That is, the scan-to-projection function described above allows the projector 10 to project a document or a photograph read with the scanner 50 on the screen 28.

After performing the scan-to-projection process, the user turns off the power supply switch 46 of the projector 10. The CPU 32 then deletes the binary data allocated in the RAM 36, and stops supplying electric power to each portion. The scanner 50 also deletes the firmware XA allocated in the internal memory when the power supply is turned off.

While, the example of how to use the projector 10 shown in FIG. 2 has been described with reference to the case where the model-X scanner 50 is connected to the projector 10, the model-Y scanner 52 can also be connected to the projector 10 in the same manner so that the user benefits from the scan-to-projection function. That is, the projector 10 can use various types of scanners. To use the model-Y scanner 52, binary data containing firmware that is necessary when the model-A projector 10 is used with the model-Y scanner 52 is of course inputted from the web server 60.

The relationship between the components in the present embodiment and the components in an aspect of the disclosure will be clarified below. The projector 10 in the present embodiment corresponds to a host apparatus in an aspect of the present disclosure. The RAM 36 corresponds to a storage unit. The USB host interface 42 corresponds to a device connection unit. The network interface 38 corresponds to a communication unit. The CPU 32, the network controller 40, and the USB controller 44 correspond to a control unit. The firmware XA corresponds to a host apparatus supporting program. The present embodiment clarifies an example of a host apparatus control method of an aspect of the invention by describing the operation of the projector 10.

According to the projector 10 of the present embodiment that has been described in detail, the RAM 36 does not need to store all firmware programs that are necessary for various types of scanners, but the RAM 36 only needs to store binary data containing firmware necessary for a scanner to be used. The storage capacity of the RAM 36 can therefore be advantageously small. Further, the projector 10 of the present embodiment can be used with a USB device that does not permanently hold a host apparatus supporting program or cannot download such a program by itself, such as the model-X scanner 50. Moreover, since the binary data stored in the RAM 36 is deleted when the power supply switch 46 is turned off, no unnecessary data is left in the RAM 36 of the projector 10 when the power supply switch 46 is turned on next time.

The invention is not limited to the embodiment described above, but may be implemented in a variety of aspects as long as they are within the technical extent of the disclosure.

In the embodiment described above, when the power supply switch 46 of the projector 10 is turned off, the binary data allocated in the RAM 36 is deleted. The binary data may alternatively be deleted, for example, when the user is finished with the scanner 50 (for example, when the scanner 50 is disconnected from the USB host interface 42). The corresponding capacity of the RAM 36 can thus be freed. The firmware XA may be deleted from the binary data after the firmware XA is saved in the scanner 50.

While the above embodiment has been described with reference to the case where the USB device connected to the projector 10 is the scanner 50, the USB device connected to the projector 10 may be a tablet or a digital camera. In this case, the projector can project an illustration or a picture created on the tablet onto a screen, or the projector can project an image captured with the digital camera onto a screen.

While the above embodiment has been described with reference to firmware, the firmware may be replaced with a driver or an interpreter.

While the transmissive liquid crystal panels 24R, 24G, and 24B are used in the embodiment described above, the transmissive liquid crystal panels are not necessarily used. Any other suitable devices based on other technologies, such as a DMD (Digital Micromirror Device: a trademark of Texas Instruments), may be used.

In the embodiment described above, an external storage medium on which the binary data containing the firmware XA is written is connected to the host apparatus via the USB host interface. The connection is not necessarily made with a USB host interface, but may be made with IrDA, Bluetooth®, or any other suitable wireless communication protocol.

What is claimed is:

1. A host apparatus capable of sending and receiving data to and from any of a plurality of devices, the host apparatus comprising:
a storage unit that temporarily stores the data;
a device connection unit that is connectable to any of the plurality of devices;
a communication unit that communicates with a server that stores binary data containing a host apparatus supporting program that is necessary when the host apparatus is used with a predetermined one of the plurality of devices and a download program that downloads the host apparatus supporting program to the predetermined device; and
a control unit that recognizes the predetermined device when the predetermined device is connected to the device connection unit, outputs a request to acquire the binary data to the server via the communication unit, stores the binary data in the storage unit when the server inputs the binary data, executes the download program contained in the binary data stored in the storage unit to download the host apparatus supporting program to the predetermined device, and deletes the binary data from the storage unit after the download program is executed or when the use of the predetermined device is completed.

2. The host apparatus according to claim 1,
wherein the control unit deletes the binary data from the storage unit when the control unit detects the turning off of a power supply switch to be the completion of the use of the predetermined device.

3. The host apparatus according to claim 1,
wherein the control unit deletes the binary data from the storage unit when the control unit detects the disconnection of the predetermined device from the device connection unit to be the completion of the use of the predetermined device.

4. The host apparatus according to claim 1,
wherein the predetermined device is any of a scanner, a tablet, and a digital camera, and
the host apparatus is a projector.

5. A method for controlling a host apparatus including a storage unit that temporarily stores data, a device connection unit that is connectable to any of a plurality of devices, and a communication unit that communicates with a server that stores binary data containing a host apparatus supporting program that is necessary when the host apparatus is used with a predetermined one of the plurality of devices and a download program that downloads the host apparatus supporting program to the predetermined device, the method comprising:
recognizing the predetermined device when the predetermined device is connected to the device connection unit, and outputting a request to acquire the binary data to the server via the communication unit, and
after the recognition of the device and the output of the request, storing the binary data in the storage unit when the server inputs the binary data, executing the download program contained in the binary data stored in the storage unit, and deleting the binary data from the storage unit after the download program is executed or when the use of the predetermined device is completed.

6. A method for controlling a host apparatus connected to a server via a communication line and connectable to any of a plurality of devices, the method comprising:
recognizing a predetermined device when the predetermined one of the plurality of devices is connected to the host apparatus,
outputting a request to acquire binary data to the server that stores binary data containing a host apparatus supporting program that is necessary when the host apparatus is used with the predetermined device and a download program that downloads the host apparatus supporting program to the predetermined device, and
storing the binary data in a storage unit of the host apparatus when the server inputs the binary data,
executing the download program contained in the binary data stored in the storage unit for downloading the host apparatus supporting program to the predetermined device, and
deleting the binary data from the storage unit after the download program is executed or when the use of the predetermined device is completed.
